(19) United States
(12) Patent Application Publication
(10) Pub. No.: US 2019/0199163 A1
(43) Pub. Date: Jun. 27, 2019

(54) MOTOR RETAINER

(71) Applicant: Continental Automotive Systems, Inc., Auburn Hills, MI (US)

(72) Inventors: James D Baer, Gurnee, IL (US); Edward Hribar, Palos Hills, IL (US); Timothy J Trento, Bloomingdale, IL (US); Keith Joseph Rodrigues, Palatine, IL (US)

(73) Assignee: Continental Automotive Systems, Inc., Auburn Hills, MI (US)

(21) Appl. No.: 15/850,269

(22) Filed: Dec. 21, 2017

(51) Int. Cl. H02K 5/26

(52) U.S. Cl. CPC H02K 5/26

(57) ABSTRACT

A motor retainer includes a base and at least one arm. The base has an inner surface and an outer surface and includes a washer having at least one concave wave adjacent to at least one convex wave. The at least one arm extends away from the inner surface of the base and tapers towards a center of the motor retainer.

### TECHNICAL FIELD

This disclosure relates to a motor retainer for retaining a motor within a motor housing.

### BACKGROUND

Electric motor systems usually include a motor, a leadframe connected to the motor, and a motor housing configured and sized to receive the motor and the motor leadframe. During assembly, the leadframe is connected to the motor, and then the leadframe-motor assembly is inserted into the motor housing. Several difficulties arise when assembling the motor system. Currently, during assembly, the leadframe-motor assembly is inserted into the housing, more specifically dropped into the housing, which might cause damage to the motor or the leadframe or both. Another difficulty during assembly is correctly positioning the leadframe-motor assembly within the housing. Lastly, it is also difficult to prevent motor rocking or motor vibration during assembly. Therefore, it is desirable to improve the assembly of the electric motor system to better position the leadframe-motor assembly within the motor and reduce motor rocking and vibration.

### SUMMARY

One aspect of the disclosure provides a motor retainer having a base and at least one arm. The base has an inner surface and an outer surface and includes a washer having at least one concave wave adjacent to at least one convex wave. The at least one arm extends away from the inner surface of the base and tapers towards a center of the motor retainer.

Implementations of the disclosure may include one or more of the following optional features. In some implementations, the at least one arm extends away from the at least one concave wave. In some examples, the base includes an outer portion having an inner diameter greater than an outer diameter of the washer.

The at least one arm may include a proximal end connected to the base and tapering towards the center of the washer, a distal end, and an elbow between the proximal end and the distal end. The distal end tapers away from the center of the motor retainer.

In some implementations, an overmold covers a portion of the at least one arm. The overmold may be a plastic overmold or a rubber overmold.

In some examples, the base defines a transverse axis and a longitudinal axis. The base extends along a plane defined by the transverse axis and the longitudinal axis. The at least one arm may form an acute angle with the plane. The acute angle may be less than 20 degrees.

Another aspect of the disclosure provides a yoke motor retainer that includes a base, a connector, a cylindrical arm, a window, and a protrusion. The base has an inner surface and an outer surface and includes a washer having at least one concave wave adjacent to at least one convex wave. The connector extends away from the inner surface of the base. The cylindrical arm is supported by the connector and extends away from the base. The window is defined by the cylindrical arm and includes window edges. The protrusion extends away from at least one window edge and away from the cylindrical arm.

Implementations of this aspect of the disclosure may include one or more of the following optional features. In some implementations, the window includes a first cutout and a second cutout. Additionally, the protrusion may include an elbow extending away from a first window edge to a second window edge being opposite to the first window edge. The elbow may have a concave shape. In some examples, the protrusion includes a finger extending away from a first window edge.

### DESCRIPTION OF DRAWINGS

FIG. 1A is a perspective view of an exemplary motor retainer.

FIG. 1B is an exploded view of a motor housing configured to receive the exemplary motor retainer of FIG. 1A.

FIG. 1C is a sectional view of a motor housing supporting the exemplary motor retainer of FIG. 1A.

FIG. 1D is a sectional view of a motor-leadframe assembly partially inserted in the housing supporting the exemplary motor retainer of FIG. 1A.

FIG. 1E is a sectional view of the motor-leadframe assembly partially inserted in the housing supporting the exemplary motor retainer of FIG. 1A, where the leadframe is adjusted to fit in the housing.

FIG. 1F is a sectional view of the motor-leadframe assembly, the exemplary motor retainer, and the housing of FIG. 1E.

FIG. 1G is a sectional view of the motor-leadframe assembly received by the exemplary motor retainer and housed by the motor housing.

FIG. 1H is a sectional view of the motor-leadframe assembly, the exemplary motor retainer, and the motor housing of FIG. 1G.

FIG. 2A is a perspective view of an exemplary motor retainer.

FIG. 2B is a perspective view of the exemplary motor retainer of FIG. 2B having arm covers.

FIG. 3 is a schematic view of an exemplary arrangement of operations for inserting a motor into a motor housing having the motor retainer of FIGS. 1A-2B.

FIG. 4A is a side bottom perspective view of an exemplary yoke motor retainer.

FIG. 4B is a side top perspective view of the exemplary yoke motor retainer of FIG. 4A.

FIG. 4C is a perspective view of an exemplary yoke motor retainer having support fingers.

FIG. 4D is a perspective view of the exemplary motor retainer of FIG. 4A supporting a motor.

FIG. 5 is a schematic view of an exemplary arrangement of operations for inserting a motor into a motor housing having the motor retainer of FIGS. 4A-4D.

Like reference symbols in the various drawings indicate like elements.

### DETAILED DESCRIPTION

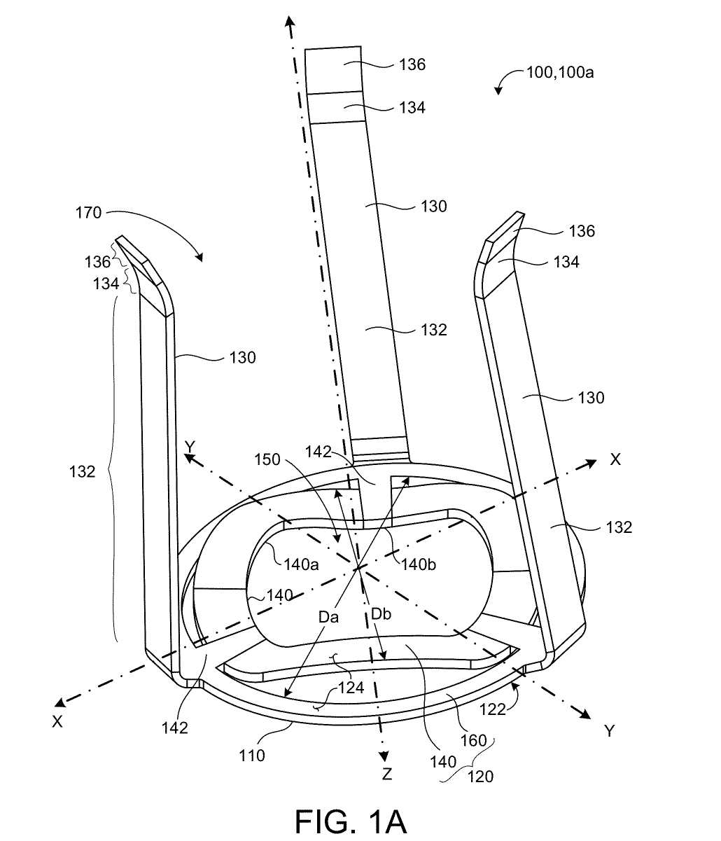

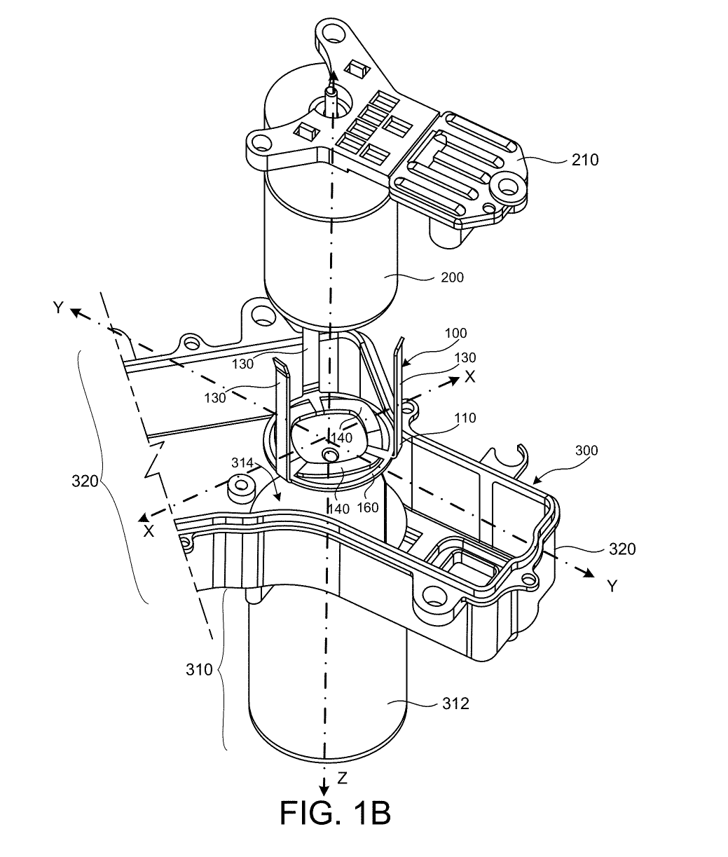

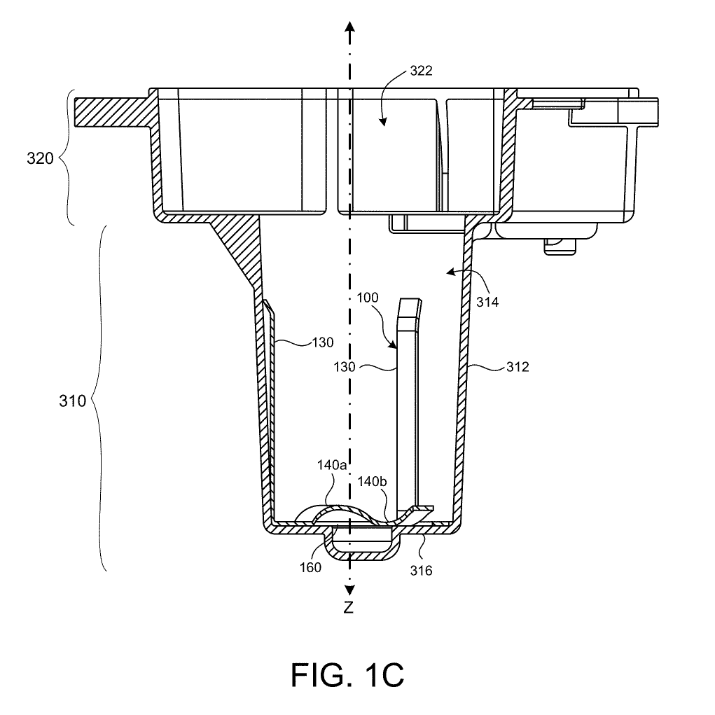

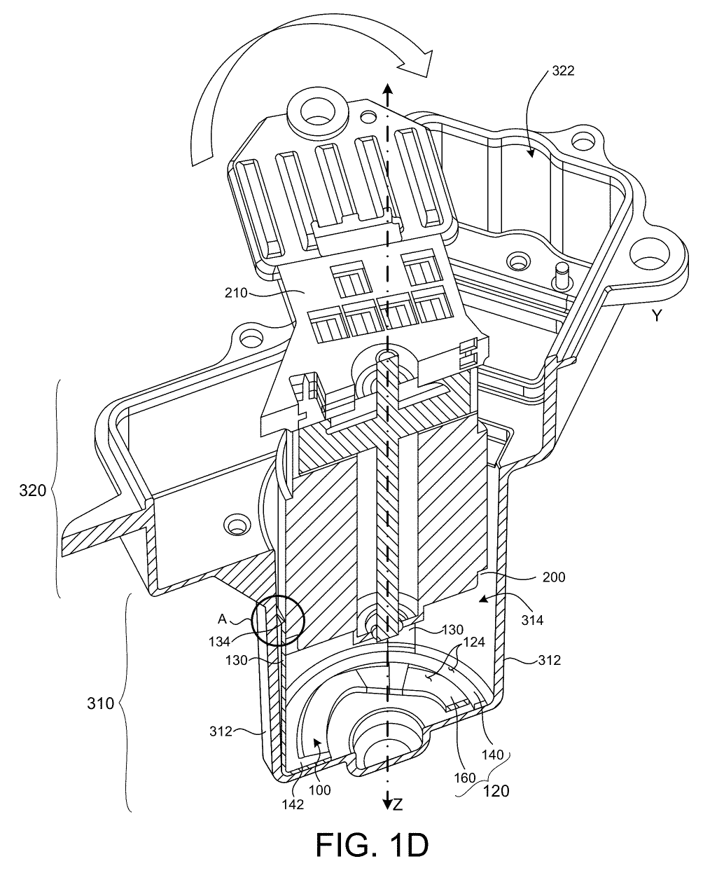

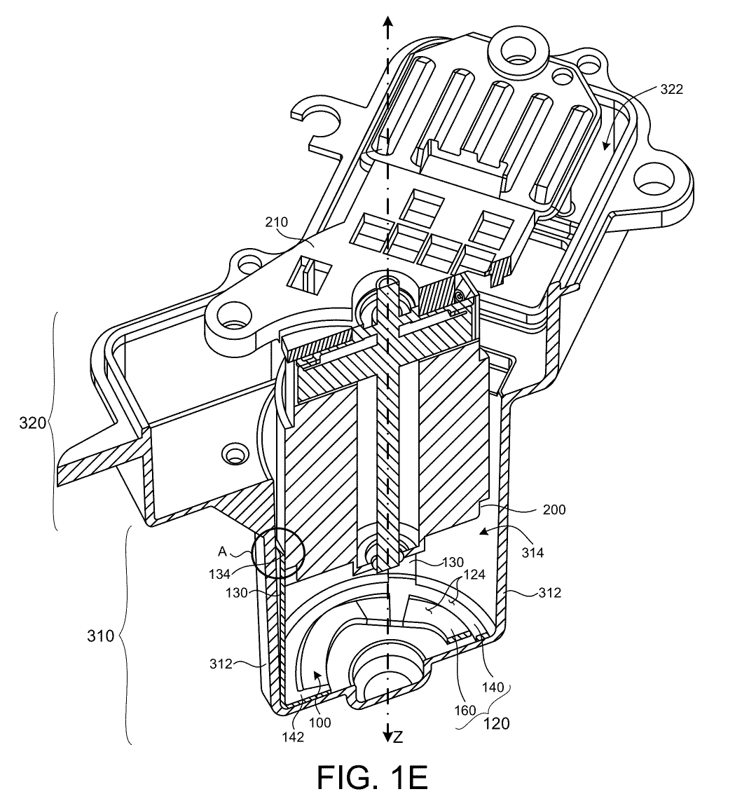

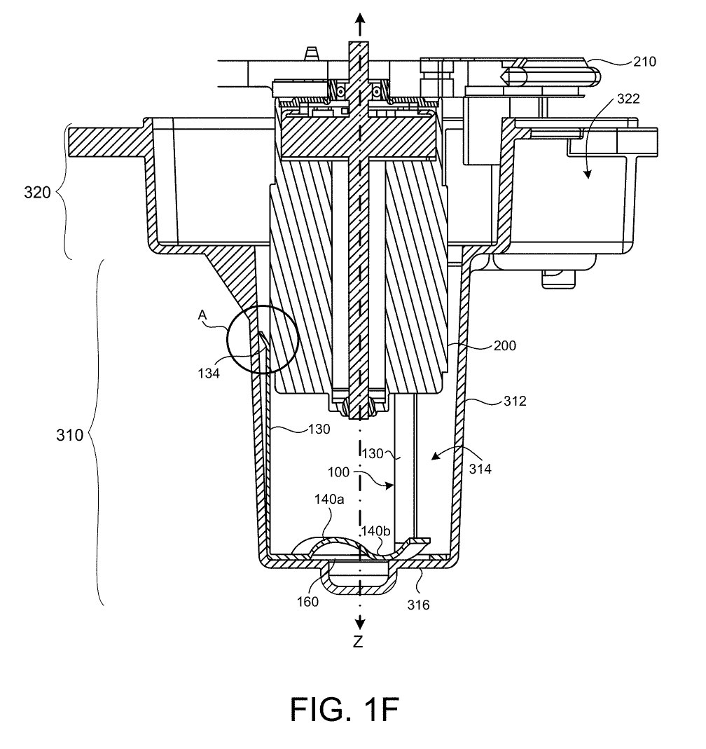

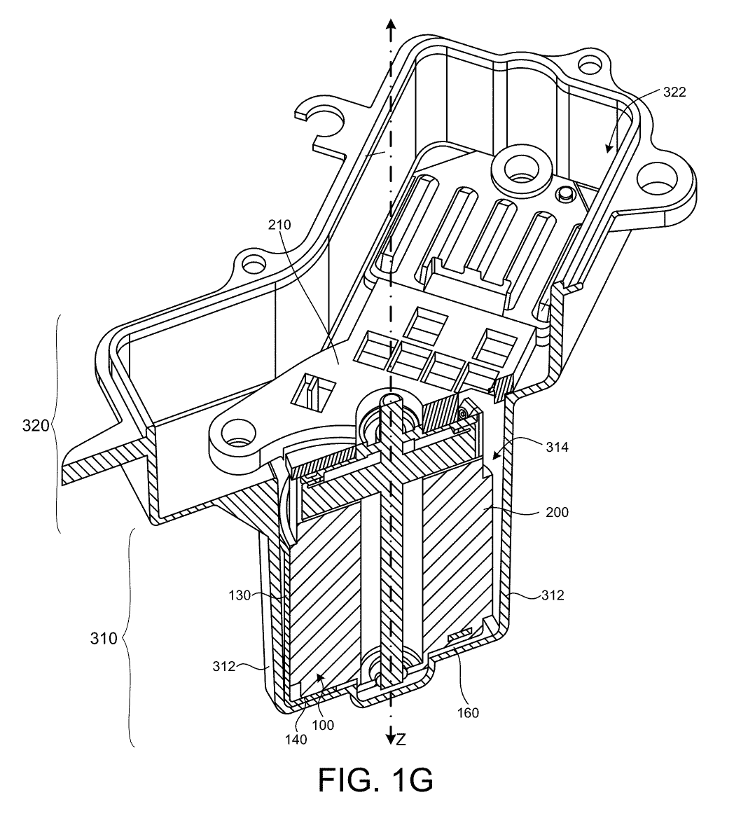

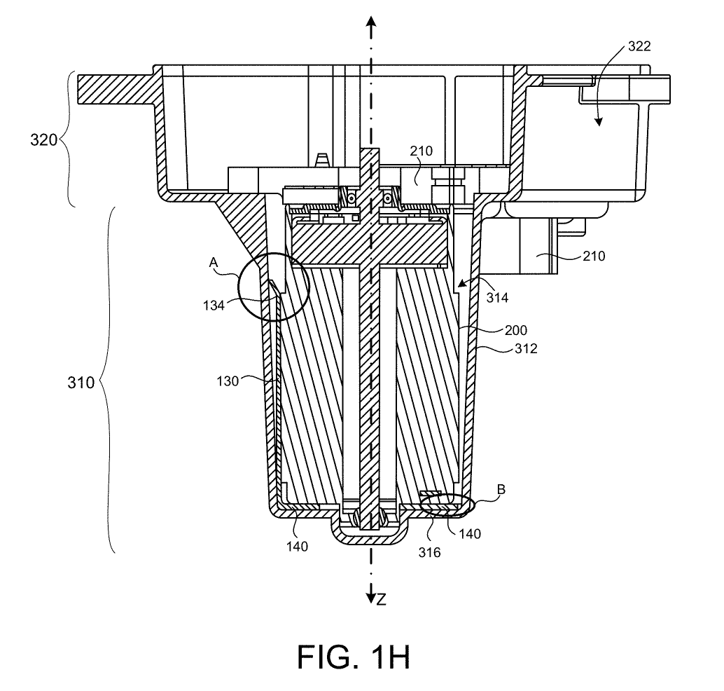

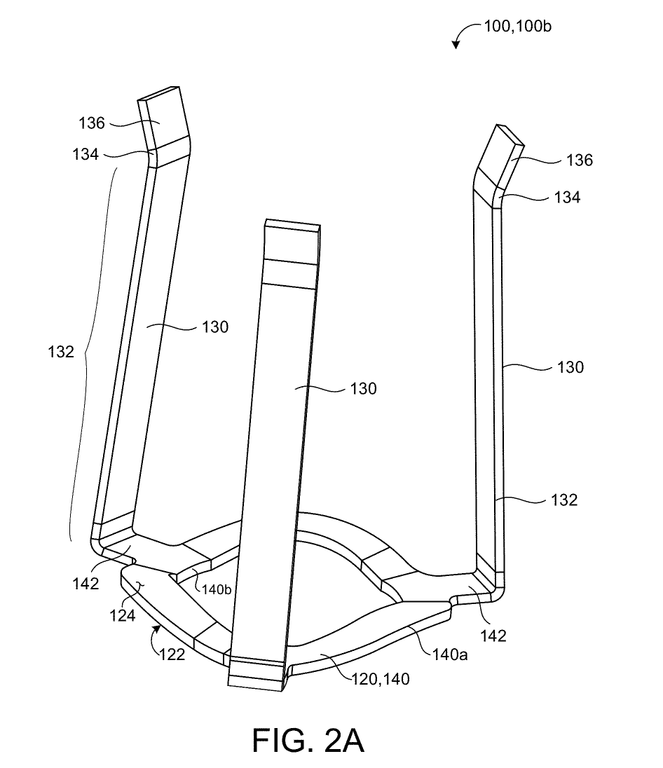

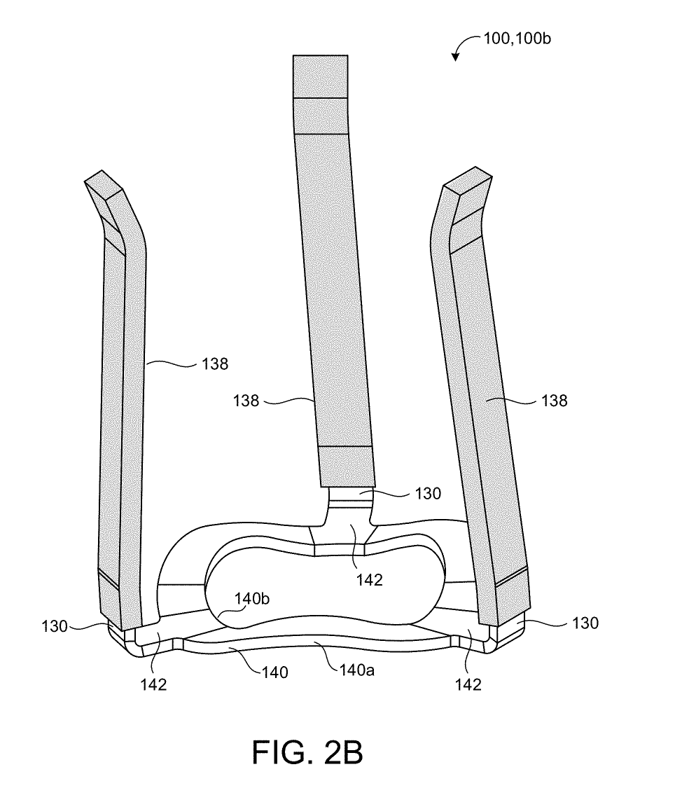

Referring to FIGS. 1A-2B, a motor retainer 100, 100a, 100b includes a body 110 having a base 120 and at least one arm 130 extending away from the base 120. The base 120 defines a transverse axis X and a longitudinal axis Y. In some examples, the base 120 extends along an X-Y plane defined by the transverse axis X and the longitudinal axis Y. The body 110 defines a central vertical axis Z. In some examples, the arms 130 are equally spaced about the central vertical axis Z from a top view. As shown, the body 110 includes three arms that are spaced trilaterally (e.g., 120 degrees apart) about the central vertical axis Z. The body 110 may include any number of arms 130, for example, the body 110 may include four arms 130 that are spaced quadrilateraly (e.g., 90 degrees apart) about the vertical axis Z. In other examples, the arms 130 are not equally spaced apart.

The base 120 includes an outer surface 122 and an inner surface 124 opposite the outer surface 122. The at least one arm 130 extends away from the inner surface 124 of the base 120. The base 120 includes a washer 140 defining a center opening 150. The washer 140 includes at least one concave wave portion 140a adjacent to at least one convex wave portion 140b. As shown, the washer 140 includes three concave wave portions 140a and three convex wave portions 140b. Each concave wave portion 140a is positioned between first and second convex wave portions 140b. Similarly, each convex wave portion 140b is positioned between first and second concave wave portion 140a. In some examples, the washer 140 may include more concave and convex wave portions 140a, 140b. A center of the convex wave portion 140b is flush with the X-Y plane, and a center of the concave wave portion 140a curves away from the X-Y plane.

Referring to FIGS. 1A-1H, in some implementations, the base 120 includes an outer portion 160 defining an inner diameter Da being greater than an outer diameter Db of the washer 140. The outer portion 160 surrounds the washer 140. In some examples, the washer 140 and the outer portion 160 are concentric about center axis Z. As such, the outer portion 160 surrounds the washer 140 and is separated from the washer 140 by a distance. At least one connector area 142 connects the washer 140 and the outer portion 160. In some examples, the connector area 142 connects to the washer 140 at the convex wave portion 140b. In some examples, the center of the convex wave portion 140b is coplanar with the outer portion 160 of the base 120. Therefore, the concave wave portion 140a extends away from the X-Y plane defined by the outer portion 160.

With continued reference to FIGS. 1A-2B, the arm 130 extends away from the base 120. In some examples, the arm 130 forms an acute angle with the base 120, i.e., the X-Y plane. As shown, the motor retainer 100 includes three arms 130 equally spaced around the periphery of the base 120. In other words, the arms 130 are tapered towards the center axis Z. In some examples, each arm 130 includes a proximal end 132, an elbow 134 and a distal end 136. The proximal end 132 of the arm 130 tapers in towards the center axis Z, the elbow 134 connects the proximal end 132 and the distal end 136 which tapers away from the center axis Z. The arms 130 form a receptacle 170 for receiving a motor 200, e.g., a brushed DC motor. The shape of the arms 130 allow the motor 200 to be retained by the elbows 134 providing slow and controlled insertion during assembly and prevents the motor 200 from rocking during operation.

FIGS. 1B-1H show a motor retainer 100 retaining the motor 200, e.g., a brushed DC motor. Referring to FIG. 1B, the motor 200 is releasably connected to a motor leadframe 210. A housing 300 includes a lower housing portion 310 configured to support the motor 200 and an upper housing portion 320 defining a receptacle 322 configured to support and receive a motor leadframe 210. The lower housing portion 310 has a cylindrical wall 312 configured to receive the motor retainer 100 and the motor 200 in a lower housing receptacle 314. The cylindrical wall 312 is sized to receive the motor 200. In some examples, the housing 300 is a die cast housing.

With additional reference to FIG. 1C, the motor retainer 100 is inserted into the housing 300, e.g., the lower housing portion 310. The outer surface 122 of the base 120 engages with a bottom portion 316 of the housing 300.

FIGS. 1D and 1E illustrate a partial insertion of the motor 200 into the motor retainer 100 that is positioned within the lower portion 310 of the housing 300. The arms 130 of the motor retainer 100, e.g., the elbows 134, hold the motor 200 preventing it from dropping in the lower portion 310 of the housing and allowing for rotational alignment of the motor leadframe 210 prior to fully inserting the motor 200 into the housing 300. The arms 130, e.g., the elbows 134, allow for a controlled insertion of the motor 200 due their shape that provides a grip about the motor 200 as shown in section A.

Referring to FIGS. 1E and 1F, once the motor leadframe 210 is aligned with the leadframe housing portion 320, the motor 200 is fully inserted into the lower housing portion 310 causing the leadframe to be inserted into the leadframe housing 320 as shown in FIGS. 1G and 1H and the motor 200 inserted into the motor retainer 100.

FIGS. 1G and 1H show the motor 200 fully inserted within the motor retainer 100. As shown, at section A, the arms 130, e.g., the elbows 134, retain the motor 200 by providing side retention to prevent the motor 200 from rocking. Moreover, the connector areas 142 restrict the lateral movement of the wave washer 140. Once the motor 200 is received by the motor retainer 100, the wave washer 140 is compressed as shown in section B providing axial motor load. In addition, the motor retainer 100 is designed to center the motor 200 within the motor receptacle 170.

Referring to FIG. 2A, in some implementations, the motor retainer 100b includes a body 110 having a base 120 and at least one arm 130 as described with respect to FIGS. 1A-1H. As shown, the body 110 includes a base 120 having a washer 140. The washer 140 is similar to the washer described with respect to FIGS. 1A-1H. As shown, the connection area 142 connects the arms 130 and the washer 140, e.g., the convex portion 140b of the washer 140.

Referring to FIG. 2B, in some implementations, the arms 130 may include an overmold 138, e.g., plastic or rubber or any other material, as shown in FIG. 2B. The overmold 138 may cover the arms 130 or a partial portion of the arms 130. For example (not shown), the overmold 138 may cover the elbow 134 and the distal ends 136 of the arm 130 to provide a better grip of the motor 200 during installation.

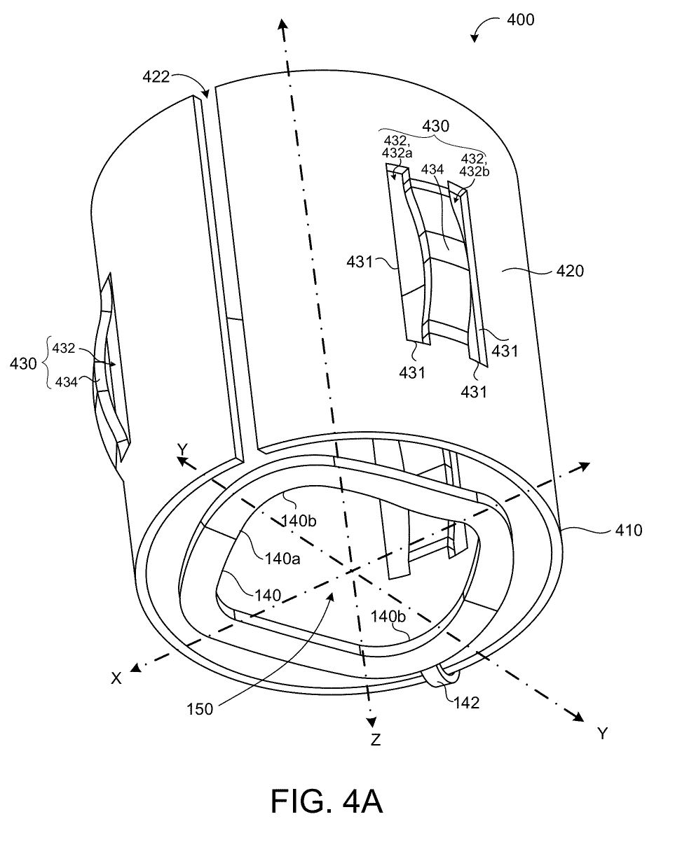

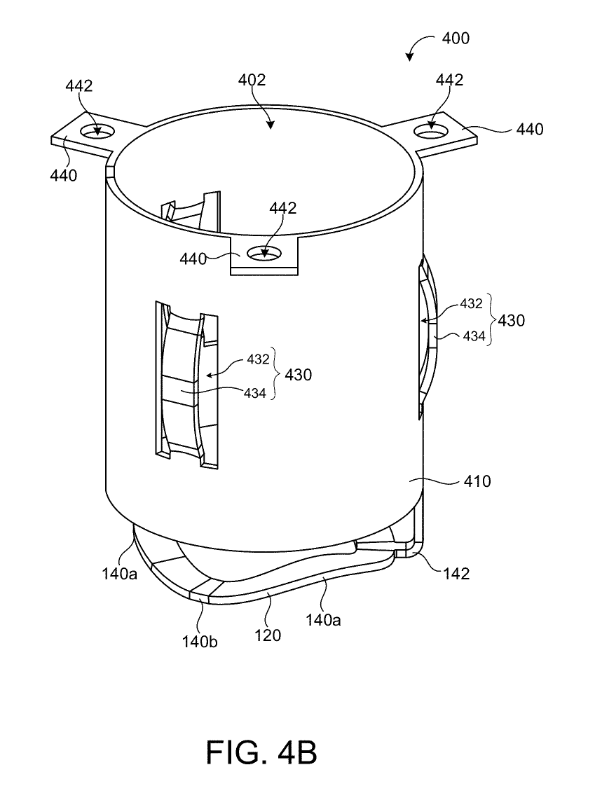

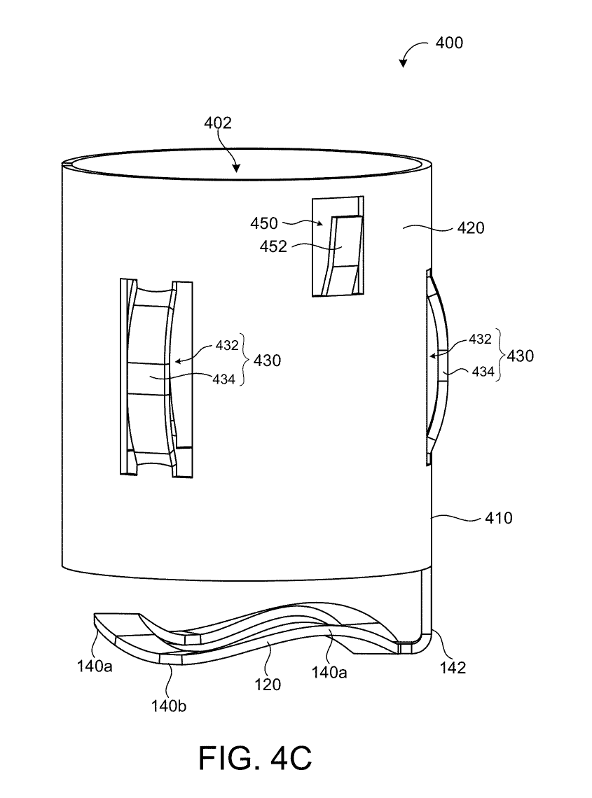

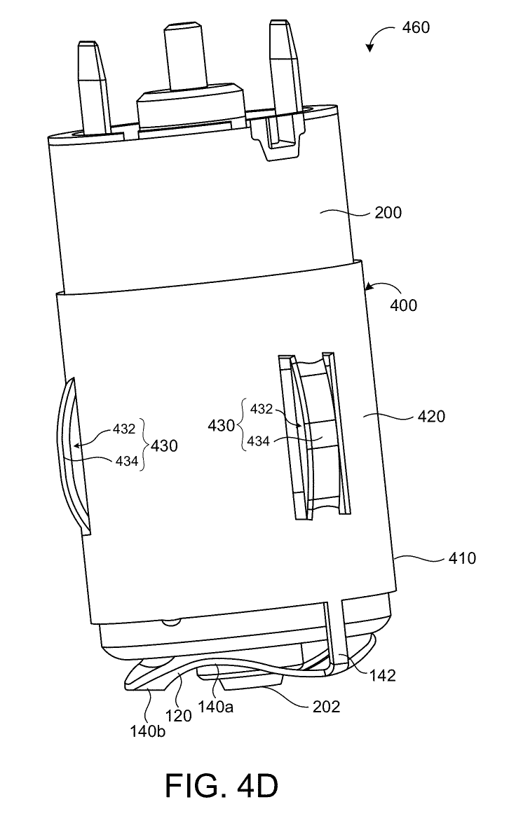

FIG. 4 provides an example arrangement of operations for a method M300 of assembling a motor system having a motor retainer 100, a motor-leadframe assembly including a motor 200 and a motor leadframe 210, and a motor housing 300 according to FIGS. 1A-2B. At block M302, the method M300 includes inserting the motor retainer 100 in the receptacle 322 of the lower portion 310 of the housing. At block M304, the method M300 includes partially inserting the motor-leadframe assembly in the receptacle 170 defined by the arms 130 of the motor retainer 100. At block M306 the method M300 includes adjusting the motor-leadframe assembly for alignment with the second portion 320 of the motor housing 300. At block M308, the method M300 includes controllably inserting the motor-leadframe assembly in the housing 300.

Referring to FIGS. 4A-4D, in some implementations, a yoke motor retainer 400 includes a body 410 having a washer 140 and a cylindrical arm 420 defining a receptacle 402 for receiving a motor 200. The washer 140 is connected to the cylindrical arm 420 by way of at least one connector 142. The washer 140 defines a center opening 150. The washer 140 includes at least one concave wave portion 140a adjacent to at least one convex wave portion 140b. As shown, the washer 140 includes three concave wave portions 140a and three convex wave portions 140b. Each concave wave portion 140a is positioned between first and second convex wave portions 140b. Similarly, each convex wave portion 140b is positioned between first and second concave wave portion 140a. In some examples, the washer 140 may include more concave and convex wave portions 140a, 140b. A center of the convex wave portion 140b is flush with an X-Y plane defined by a transverse axis X and a longitudinal axis Y. The cylindrical arm 420 extends away from the X-Y plane along a central vertical axis Z. The cylindrical arm 420 may define a trough 422 extending along a height of the cylindrical arm 420. In some examples, the cylindrical arm 420 defined more than one trough 422 extending along the height of the cylindrical arm 420. In this case, the yoke motor retainer 400 includes additional connectors 142 connecting each portion of the cylindrical arm 420 with the washer 140.

In some implementations, the cylindrical arm 420 is used as a motor flux yoke. A motor yoke is the body of a motor, e.g., AC motor or DC motor. The motor yoke supports the motor poles, provides an outer most cover for the motor, and forms a magnetic circuit. Therefore, the cylindrical arm 420 provides extra motor shield cover to eliminate electromagnetic interference (EMI).

As shown, the cylindrical arm 420 of the motor retainer 400 defines one or more windows 430 having window edges 431, where each window 430 has at least two cutouts 432 separated by a mullion or elbow 434. As shown, the window 430 includes a first cutout 432a separated from a second cutout 432b by a mullion or elbow 434 extending between the first and second cutouts 432a, 432b. The mullion or elbow 434 has a concave shape with respect to the cylindrical arm 420 and extends away from the cylindrical arm 420. Similar to the elbow 134 described with respect to FIGS. 1A-2B, the elbow 434 allows the yoke motor retainer 400 to be controllably inserted within a housing of the motor (not shown).

Referring to FIG. 4B, in some implementations, the yoke motor retainer 400 includes integrated mounting tabs 440, each defining a hole 442. The hole 442 is sized to receive a bolt or a screw for mounting the yoke motor retainer 400.

Referring to FIG. 4C, in some implementations, the cylindrical arm 420 of the motor retainer 400 further defines another window 450 that includes a finger 452 extending within the window 450 and extending away from the cylindrical arm 420. The finger 452 provides additional grip and controlled movement during assembly of the yoke motor retainer 400 (while supporting the motor 200) within the lower portion 310 of the housing 300.

In some implementations, the base 120 of the yoke motor retainer 400 may include an outer portion 160 as described in FIGS. 1A-1H. Additionally or alternatively, the elbows 434 and/or the fingers 452 may be overmolded to provide added grip between the yoke motor retainer 400 and the housing 300.

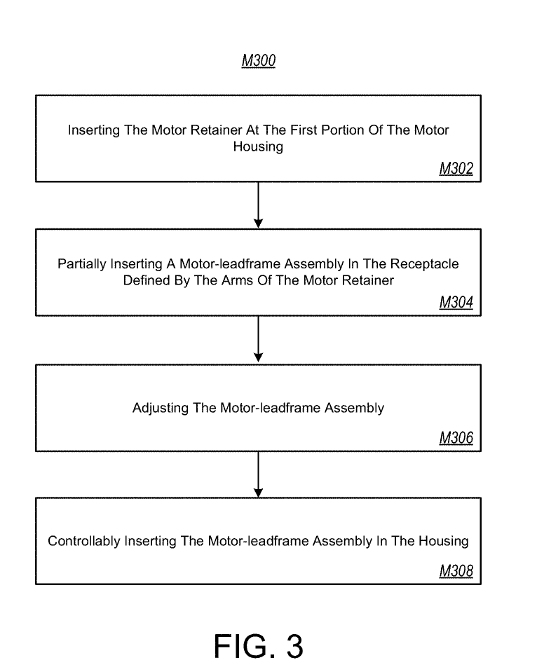

Referring to FIG. 4D, during assembly, the motor 200 is inserted into the yoke motor assembly 400. The cylindrical arm 420 provides a tight grip around the motor 200 and the center 150 received a motor shaft 202. The motor-retainer assembly 460 shown in FIG. 3D is then controllably released in the lower portion 310 of the housing 300.

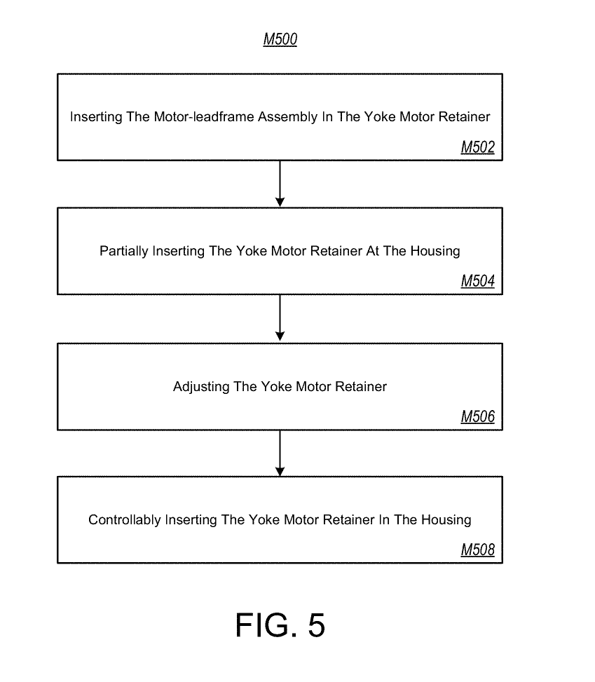

FIG. 5 provides an example arrangement of operations for a method M500 of assembling a motor system having a yoke motor retainer 400, a motor-leadframe assembly including a motor 200 and a motor leadframe (not shown), and a motor housing 300 according to FIGS. 4A-4D. At block M502, the method M500 includes receiving the motor-leadframe assembly in the receptacle 402 of the yoke motor retainer 400. At block M504, the method M500 includes partially inserting the yoke motor retainer 400 in the receptacle 322 of the lower portion 310 of the housing (not shown). At block M506, the method M500 includes adjusting the yoke motor retainer 400 to align the motor leadframe with the second portion of the motor housing configured to receive the motor leadframe. At block M508, the method M300 includes controllably inserting the yoke motor retainer (including the motor 200 and motor leadframe) in the housing (not shown).

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A motor retainer comprising:
a base having an inner surface and an outer surface, the base including a washer having at least one concave wave adjacent to at least one convex wave; and
at least one arm extending away from the inner surface of the base and tapering towards a center of the motor retainer.

2. The motor retainer of claim 1, wherein the at least one arm extends away from the at least one concave wave.

3. The motor retainer of claim 1, wherein the base includes an outer portion having an inner diameter greater than an outer diameter of the washer.

4. The motor retainer of claim 1, wherein the at least one arm comprises a proximal end connected to the base and tapering towards the center of the washer, a distal end, and an elbow between the proximal end and the distal end, the distal end tapering away from the center of the motor retainer.

5. The motor retainer of claim 1, further comprising an overmold covering a portion of the at least one arm.

6. The motor retainer of claim 5, wherein the overmold is a plastic overmold.

7. The motor retainer of claim 5, wherein the overmold is a rubber overmold.

8. The motor retainer of claim 1, wherein the base defines a transverse axis and a longitudinal axis, the base extends along a plane defined by the transverse axis and the longitudinal axis.

9. The motor retainer of claim 8, wherein the at least one arm forms an acute angle with the plane.

10. The motor retainer of claim 9, wherein the acute angle is less than 20 degrees.

11. A yoke motor retainer comprising:
a base having an inner surface and an outer surface, the base includes a washer having at least one concave wave adjacent to at least one convex wave;
a connector extending away from the inner surface of the base;
a cylindrical arm supported by the connector and extending away from the base;
a window defined by the cylindrical arm, the window comprising window edges; and
a protrusion extending away from at least one window edge and away from the cylindrical arm.

12. The yoke motor retainer of claim 11, wherein:
the window includes a first cutout and a second cutout; and
the protrusion includes an elbow extending away from a first window edge to a second window edge being opposite to the first window edge.

13. The yoke motor retainer of claim 12, wherein the elbow has a concave shape.

14. The yoke motor retainer of claim 11, wherein the protrusion includes a finger extending away from a first window edge.
